(19) United States
(12) Patent Application Publication
(10) Pub. No.: US 2016/0000631 A1
(43) Pub. Date: Jan. 7, 2016

(54) Biometric Calibration for Ergonomic Surgical Platforms

(71) Applicant: Charles Becker, Lexington, KY (US)

(72) Inventor: Charles Becker, Lexington, KY (US)

(21) Appl. No.: 14/321,946

(22) Filed: Jul. 2, 2014

(51) Int. Cl. A61G 15/02; G05B 19/402

(52) U.S. Cl. CPC A61G 15/02; G05B 19/402; G05B 2219/45119; G05B 2219/39024

(57) ABSTRACT

The present Invention describes a method and system for calibrating, to an optimally ergonomic position, a surgical platform for use in laparoscopic surgeries. The bases of the method include the surgical site within a patient and the laparoscopic port placements within the ventral wall of the patient arranged in a three-dimensional coordinate system, and biometric data of the surgeon conducting the laparoscopic procedure.

### BACKGROUND

Throughout recorded history, surgeons have stood tableside over their patients laid upon a surgical table through the entirety of the surgery. While surgical techniques have drastically changed over the years, the placement of the surgeon has not changed as open surgical procedures still have an optimal surgeon placement over the open body wall to view into the chest or abdominal cavity.

In the past 30 years, laparoscopic surgical procedures have been developed and increased in popularity. In an open procedure, a series of long incisions are made into the chest or abdominal cavities to fully or partially expose a surgical site. While this gives a surgeon a full view of the surgical site, it does require a substantial recovery time and leaves significant scarring through the layers of tissues through which the incisions were made. Laparoscopic procedures instead consist of puncturing holes through the layers of tissue to allow a camera and long-necked laparoscopic access to the surgical site. As long incisions are not made in through the skin and other tissues, recovery times are faster and scarring is minimized without a substantive loss in procedure efficacy.

An added benefit of laparoscopic tools is their telescopic refinement of movements at the surgical site. The ports in the abdominal wall or chest wall serve as a pivot point for the laparoscopic instruments, and these ports can be between 5 and 10 cm from the surgical site, depending on the procedure being done. Thus, for a 30 cm laparoscopic tool inserted through a laparoscopic port 10 cm to the surgical site within a patient's cavity, a 2:1 ratio between the surgeon's movements to the movement of the distal end of the laparoscopic tool is created. This is beneficial for patient outcomes as a finer movement of the distal end of the laparoscopic tool allows a surgeon to be more accurate in their movements. However, this requires larger movements of the arms from the surgeon. Further, depending on the procedure being conducted, a surgeon may need to keep his arms elevated above the patient and the above sterile field throughout the length of the procedure. This elevated degree of arm flexion and wider range of motion is ergonomically detrimental to the surgeon throughout the course of their career as they lead to excess strain and wear-and-tear on the affected joints.

Surgical platforms such as Garber (U.S. Pat. No. 3,754,787) have been described to allow surgeons to position themselves during open surgical procedures. These surgical platforms include a seat and foot rests to alleviate pressure on the feet, knees, and hips, as well as chest rests to allow a surgeon to lean toward the surgical field. This minimizes the degree of sustained flexion while also reducing the required range of motion of the arms. While surgical platforms for open surgical procedures did not gain popularity in use, the ergonomic challenges inherent with laparoscopic surgical procedures warrant a reexamination of the efficacy of surgical platforms.

Turner (U.S. Pat. No. 8,070,221) and Turner (U.S. Pat. No. 8,480,168) describe surgical platforms designed to support a surgeon over a patient during a laparoscopic procedure. Being able to be lifted over the patient or even straddling the patient allows the surgeon to assume positions not previously possible while standing to either the left or the right of the patient. This would also allow surgeons to place laparoscopic ports in the body wall of the patient where they are most advantageous in terms of patient healing outcome, as opposed to where they are most convenient for the surgeon based on his or her right or left of patient position.

Surgical platforms have many degrees of freedom allowing for the optimal positioning of the surgeon about the patient. These include, but are not limited to: seat height, foot rest height, chest rest angle, proximity to the patient, and the angle of approach to the patient. Together, these degrees of freedom combine to form an ergonomically optimal setup. However, finding this ergonomically ideal setup is time consuming and frustrating for surgeons, and unnecessarily extends surgical times while the patient is under anesthesia.

### BRIEF SUMMARY OF THE INVENTION

It is the goal of this invention to overcome the issues inherent in a surgeon attempting manually to adjust a surgical platform, as this would lead to a loss of time and an unnecessary amount of frustration. The invention described herein will determine the optimal ergonomic calibration of a surgical platform based on three sets of data: the location of the site of the surgery within the patient, the locations of the two ports placed in the body wall of the patient during the laparoscopic surgery, and the physical measurements of the surgeon conducting the laparoscopic procedures. Further, while the disclosed method and system include surgical platform measurements directed toward a particular design of a surgical platform (the ETHOS® Surgical Platform), one of ordinary skill in the art would recognize the need to adjust certain calculations based on the design specifications of whatever surgical platform is being calibrated.

The following calibration method operates within a three-dimensional coordinate system, and assumes the patient is lying in the supine position. The x-coordinate is positive on the patient's right and negative on the patient's left. The y-coordinate is positive in the direction of the patient's inferior aspects is positive, while the superior direction is negative. Finally, the z-coordinate represents the height from the floor of the operating room. The axes of the coordinate system, and the assumption that the floor directly below the surgical site within the patient (e.g., appendix, gallbladder, esophageal hiatus) serves as the origin of the coordinate system is entirely arbitrary. It would be obvious to one of ordinary skill in the art to adjust the direction of the axes or the location of the origin based on alternative patient positioning, surgical setups, or personal spatial preferences.

Once a coordinate for the site of surgery is determined, a surgeon can then determine where the laparoscopic ports will be placed in the body wall of the patient. These could be determined based on muscular and fascial structures of the abdomen or based on the gaps between the ribs, depending on the exact type of procedure, its location, and the surgeon's experience and preference. The final input to the method and system are the body measurements of the surgeon, including the length of the laparoscopic tools being utilized, the ulna length (wrist to elbow distance), humerus length (elbow to shoulder distance), shoulder width, back length (nape of the neck to the hips along the spine), femur length (hip to knee distance), and tibia length (knee to ankle length). With this information, the algorithm is able to calculate how the surgical platform should be calibrated in regards to the seat height, the chest rest angle, foot rest height, the appropriate angle of approach, and the distance the surgical platform should be from the patient.

### BRIEF DESCRIPTION OF THE DRAWINGS

FIG. 1 shows a user sitting upon a surgical platform with demonstrated degrees of freedom.

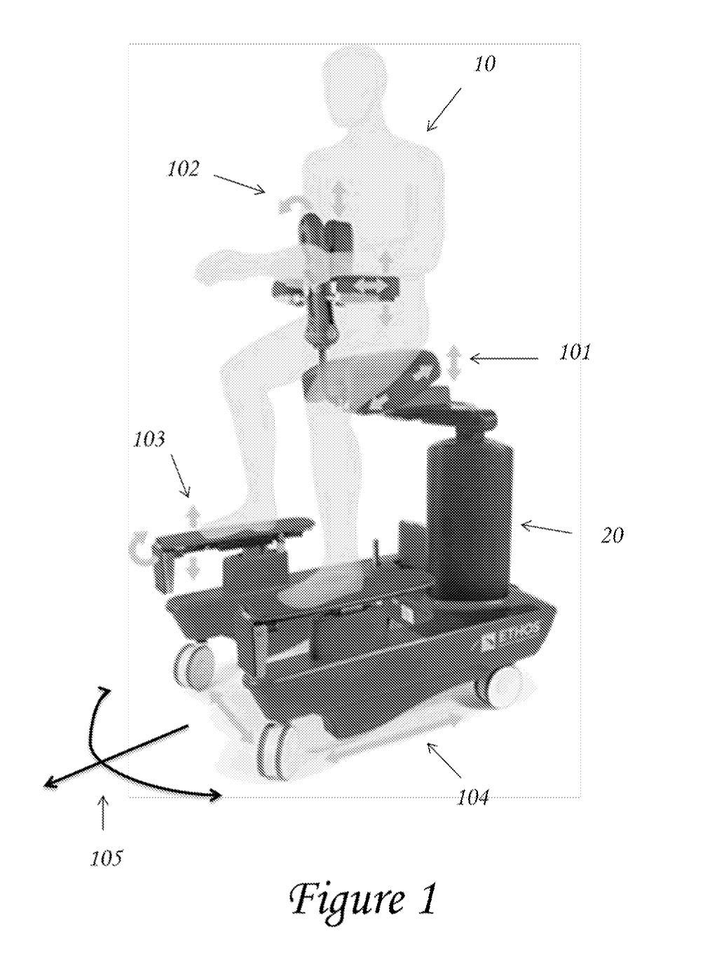

FIG. 2 shows a wire-frame model of a surgeon seated upon a surgical platform during a laparoscopic procedure.

FIG. 3 shows the user input interface and the values necessary for ergonomic calibration.

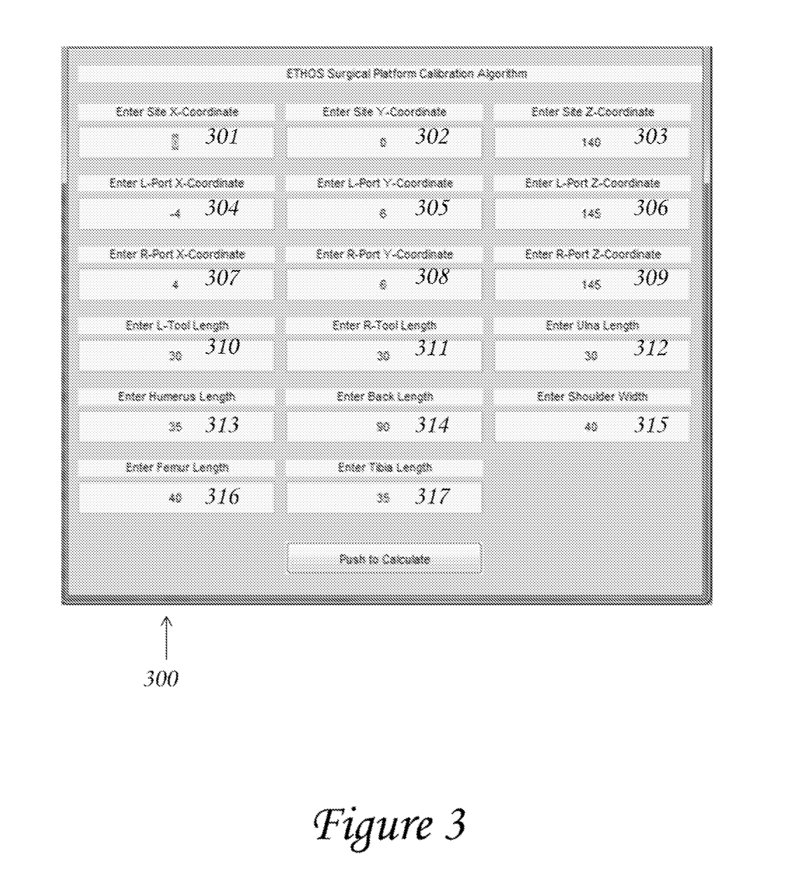

FIG. 4 shows one of the invention's outputs: a lateral representation of the surgeon sitting on the surgical platform with the calculated calibration values.

FIG. 5 shows one of the invention's outputs: a perspective representation of the surgeon sitting on the surgical platform with the calculated calibration values.

FIG. 6 shows one of the invention's outputs: a perspective representation of the surgeon sitting on the surgical platform with the calculated calibration values.

### DETAILED DESCRIPTION OF THE INVENTION

Surgical platforms, such as the ETHOS® Surgical Platform (20), have multiple degrees of freedom that must be adjusted to create an ideal ergonomic calibration for the user (10). These include, but are not limited to: seat height (101), chest rest angle (102), foot rest height (103), distance to the patient (104), and angle of approach relative to the patient (105). Other surgical platforms may have other degrees of freedom depending on their specific design, but the adjustment of any other degrees of freedom not addressed herein could be easily calculated using the following method and calculations. Further, the surgical platform (20) of the current invention includes a processor operating a computer-readable medium for the execution of a user interface used to manually calibrate the several degrees of freedom.

The following calibration method operates within a three-dimensional coordinate system, and assumes the patient is lying in the supine position. The x-coordinate is positive on the patient's right and negative on the patient's left. The y-coordinate is positive in the direction of the patient's inferior aspects is positive, while the superior direction is negative. Finally, the z-coordinate represents the height from the floor of the operating room. The axes of the coordinate system, and the assumption that the floor directly below the surgical site within the patient (e.g., appendix, gallbladder, esophageal hiatus) serves as the origin of the coordinate system is entirely arbitrary. It would be obvious to one of ordinary skill in the art to adjust the direction of the axes or the location of the origin based on alternative patient positioning, surgical setups, or personal spatial preferences. Further, the shown units and the assumed surgical platform design measurements are in centimeters, but other units would be easily substituted if it were necessitated.

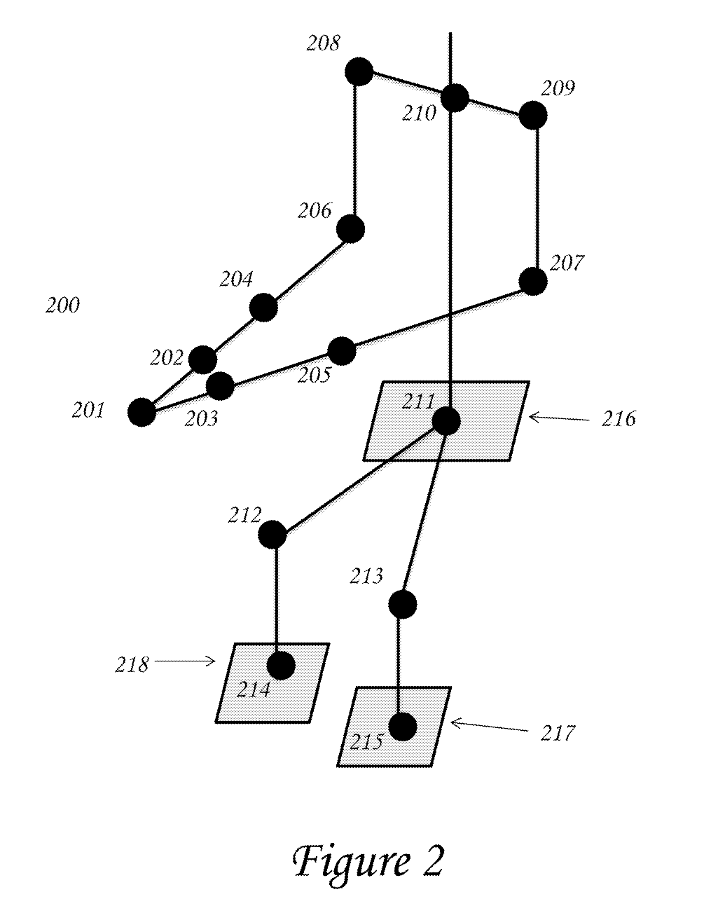

The first step in the biophysical calibration algorithm is accepting inputs from the user, whether it is the surgeon or a technician preparing the platform before the laparoscopic procedure. This is done via the user interface (300) which takes in all of the input values (301-317) before calibrating the surgical platform. The first basis of the input is the surgical site within the patient. This is accepted into the algorithm as an x-coordinate (301), y-coordinate (302), and z-coordinate (303). The next basis is the locations of the left and right laparoscopic ports, similarly represented as x-coordinates (304 and 307, respectively), y-coordinates (305 and 308, respectively), and z-coordinates (306 and 309, respectively). Finally, the algorithm requires biophysical data representing the surgeon for ideal ergonomic calibration. This includes tool lengths of the left (310) and right (311) laparoscopic tools, the surgeon's forearm length (312), the surgeon's upper arm length (313), the surgeon's back length (314), the surgeon's shoulder width (315), the surgeon's thigh length (316), and the surgeon's leg length (317). These lengths will be utilized in determining the separation of joints as will be discussed in regard to FIG. 2.

To create equidistance from the surgical site (201) to each of the elbows (206 and 207) where the shortest routes from the surgical site to the elbows extend through the laparoscopic ports (202 and 203), a proper approach angle (604) must be calculated. An arbitrary rotational axis must be created, and in the ideal mode of this invention, a rotation toward the surgeon's right is a positive rotation while a rotation to the left is a negative rotation. A vector can be established from the left (203) to right (202) laparoscopic port, and then be compared an arbitrary positive-rotational-direction vector via the dot product to determine the ergonomically ideal approach angle (604) for the surgical platform:

$$Approach Angle = {cos}^{- 1} \frac{\vec{〈 Left Port 〉 - 〈 Right Port 〉} \cdot [ 0 \; 1 \; 0 ]}{\vert 〈 Left Port 〉 - 〈 Right Port 〉 \vert \times [ 0 \; 1 \; 0 ]}$$

As will become evident, there are a number of assumptions in the determination of the ideal ergonomic calibration. The first is that in an ideal ergonomic setup the elbows of the user are directly in line from the surgical site, through the respective left and right laparoscopic ports for the length of the surgical tools and the forearms of the users. This is demonstrated in the wire-frame depiction of a surgeon using a surgical platform in FIG. 2. From the surgical site (201) within the body wall of a patient (200), a pair of straight lines travel through the left (203) and right (202) laparoscopic ports, continuing through the surgeon's left (205) and right (204) hands, and finally to the surgeon's left (207) and right (206) elbows. To determine the locations of the joints along these straight lines, an orientation vector for the left and right arms can be calculated based on the vectors from the surgical site (201) to the left (203) and right (202) laparoscopic ports:

$$\vec{Left Arm} = \frac{〈 Left Port 〉 - 〈 Surgical Site 〉}{\vert 〈 Left Port 〉 - 〈 Surgical Site 〉 \vert}$$

$$\vec{Right Arm} = \frac{〈 Right Port 〉 - 〈 Surgical Site 〉}{\vert 〈 Right Port 〉 - 〈 Surgical Site 〉 \vert}$$

With these directional vectors, the positions of the surgeon's hands (204 and 205) and elbows (206 and 207) can then be calculated based on the laparoscopic tool lengths (310 and 311).

[symbol]

Left Hand [symbol] = [symbol] Surgical Site [symbol] +(Left Tool Length)×\vec{Left Arm}

[symbol]

Right Hand [symbol] = [symbol] Surgical Site [symbol] +(Right Tool Length)×\vec{Right Arm}

[symbol]

Left Elbow [symbol] = [symbol] Surgical Site [symbol] +(Left Tool Length+Forearm Length)×\vec{Left Arm}

[symbol]

Right Elbow [symbol] = [symbol] Surgical Site [symbol] +(Right Tool Length+Forearm Length)×\vec{Right Arm}

The next important assumption in the algorithm is that the upper arms (between joints 206 and 208, and 207 and 209, respectively) should be in a position directly downward (i.e., in line with gravity). This would minimize the amount of effort required of the surgeon's shoulder musculature during the laparoscopic procedures. Thus, the directional vector from the left (206) and right (207) elbows to the left (208) and right (209) shoulders should be [0, 0, 1], which is representative of a direct rise in solely the height coordinate. Similar to the previous equations, the required positions of the shoulders then could be calculated based on that direction, the location of the elbows (206 and 207), and the length of the upper arms (313):

[symbol]

Right Shoulder [symbol] = [symbol] Right Elbow [symbol] +(Upper Arm Length)×[0 0 1]

[symbol]

Left Shoulder [symbol] = [symbol] Left Elbow [symbol] +(Upper Arm Length)×[0 0 1]

The necessary angle formed at the elbow between the forearm and the upper arm is also important as this represents the properly calibrated seat angle (602). As the required angle at the elbow becomes larger, the properly calibrated seat angle must also become larger to keep the upper arms in fully downward position. Using the dot product, and the vectors representing the orientation of the forearms and the upper arms:

$$Seat Angle = Elbow Angle = {cos}^{- 1} \frac{\vec{Right Arm} \cdot [ 0 \; 0 \; 1 ]}{\vert Right Arm \vert \times [ 0 \; 0 \; 1 ]} = {cos }^{- 1} \frac{\vec{Left Arm} \cdot [ 0 \; 0 \; 1 ]}{\vert Left Arm \vert \times [ 0 \; 0 \; 1 ]} \qquad$$

Once the preferred ergonomic position of the left (209) and right (208) shoulders have been found, the nape of the neck (210) can be calculated as the positional average between the left (209) and right (208) shoulder.

$$〈 Nape 〉 = \frac{〈 Left Shoulder 〉 + 〈 Right Shoulder 〉}{2}$$

However, as the calculated distance between the left (209) and right (208) shoulder may not be identical to the actual shoulder width (315) of the user, a correction must be made. For both the left (209) and right (208) shoulders, a directional vector can be calculated from the nape to the respective shoulder, and then multiplied by half of the shoulder width to determine a more realistic calculated left (209) and right (208) shoulder position:

$$〈 Left Shoulder 〉 = 〈 Nape 〉 + \frac{Shoulder Width}{2} \times \frac{〈 Left Shoulder 〉 - 〈 Nape 〉}{\vert 〈 Left Shoulder 〉 - 〈 Nape 〉 \vert}$$

$$〈 Right Shoulder 〉 = 〈 Nape 〉 + \frac{Shoulder Width}{2} \times \frac{〈 Right Shoulder 〉 - 〈 Nape 〉}{\vert 〈 Right Shoulder 〉 - 〈 Nape 〉 \vert} \\$$

Once the positions of the joints and limbs of the upper body have been calculated, determination of the positions of the joints and limbs of the lower body can be made. The distance from the nape (210) to the hips (211) is the back length (314), but the approach angle and the seat angle must be taken into account to determine the directional vector representing the orientation of the back. In the arbitrary coordinate system established for this algorithm, the x-coordinate and the y-coordinate of the directional vector representing back orientation are based on both the seat angle (i.e., how far away in the x-y plane the hips will be placed away from nape) and the approach angle, whereas the z-coordinate are based on the seat angle. Calculating each component separately:

\vec{Back Orientaion}ₓ=sin(Seat Angle)*sin(Approach Angle)

\vec{Back Orientaion}_{y}=sin(Seat Angle)*cos(Approach Angle)

\vec{Back Orientaion}_{z}=−sin(Seat Angle)

However, since unlike sine and cosine functions of the same angle in a two-dimensional plane, the directional vector is not necessarily a unit vector, thus a division by the absolute length of the three part back orientation is required. Thus:

$$\vec{Back Orientation} = [ \frac{{\vec{Back Orientation}}_{x} , {\vec{Back Orientation}}_{y} , {\vec{Back Orientation}}_{z}}{\sqrt{{\vec{Back Orientation}}_{x}^{2} + {\vec{Back Orientation}}_{y}^{2} + {\vec{Back Orientation}}_{z}^{2}}} ]$$

Finally, to determine the location of the hips (211) in the three-dimensional coordinate system:

<Hips>=Nape+Back Length×\vec{Back Orientation}

Now that the location of the hips is known, two more important calibration values can be calculated. First, the z-coordinate of the hips is the seat height (601) of the seat (216) of the surgical platform (20) needed for an ideal ergonomic calibration.

Seat Height=<Hips>_{z}

Also, the distance (605) that the hips (211) of the surgeon (10) to the surgical site (201) can be calculated by combining the component distances of the x-coordinate and the y-coordinate of the hips (211):

Distance=\sqrt{<Hips>ₓ²+<Hips>_{y}²}

The final calibration value, the foot rest height (603) can be calculated in a manner much simpler as x-coordinates and y-coordinates of the limbs no longer need to be determined. More complex equations could be derived by one of ordinary skill in the art to find the specific points in space of the left (213) and right (212) knees and the left (215) and right (214) feet, but for the functional goals of this embodiment, these are unnecessary. From the hips, it is further assumed that a comfortable angle of 30° decline from the hips to the left (213) and right (212) knees. This angle is arbitrary, and could be made to be modifiable by the user within the algorithm's user interface if it was deemed important to meet varying surgeon needs. Based on that angle of decline, the hips (211), and the thigh length (316):

<Knees>_{z}=<Hips>_{z}−Thigh Length×sin 30°

From the left (213) and right (212) knee heights, the height of the left (215) and right (214) feet can be calculated by subtracting the leg length (317), as it is assumed the most comfortable would be one that is directionally downward.

<Feet>_{z}=<Knees>_{z}−Leg Length

However, as this presumption may not hold for all users, the algorithm would be easily modifiable to account for a larger angle about the knee by multiplying the leg length by the sine of the angle before subtracting it from the z-coordinate of the knee. Thus, the z-coordinate of the left (215) and right (214) feet represents where the left (219) and right (218) foot rests should be placed, or the ergonomically ideal foot rest height (603).

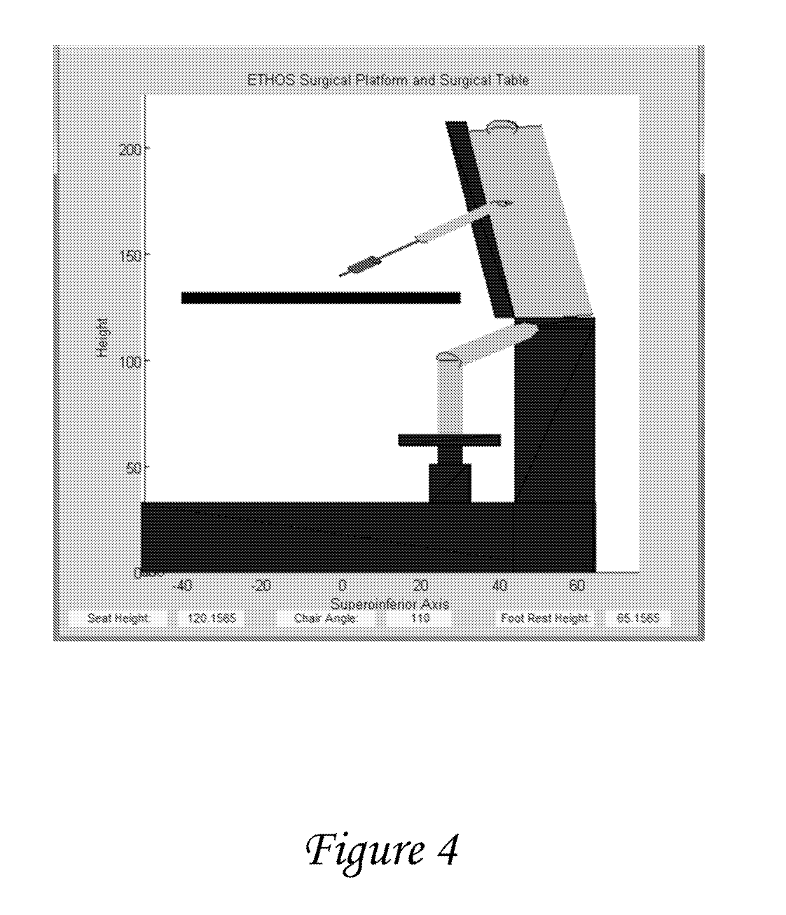

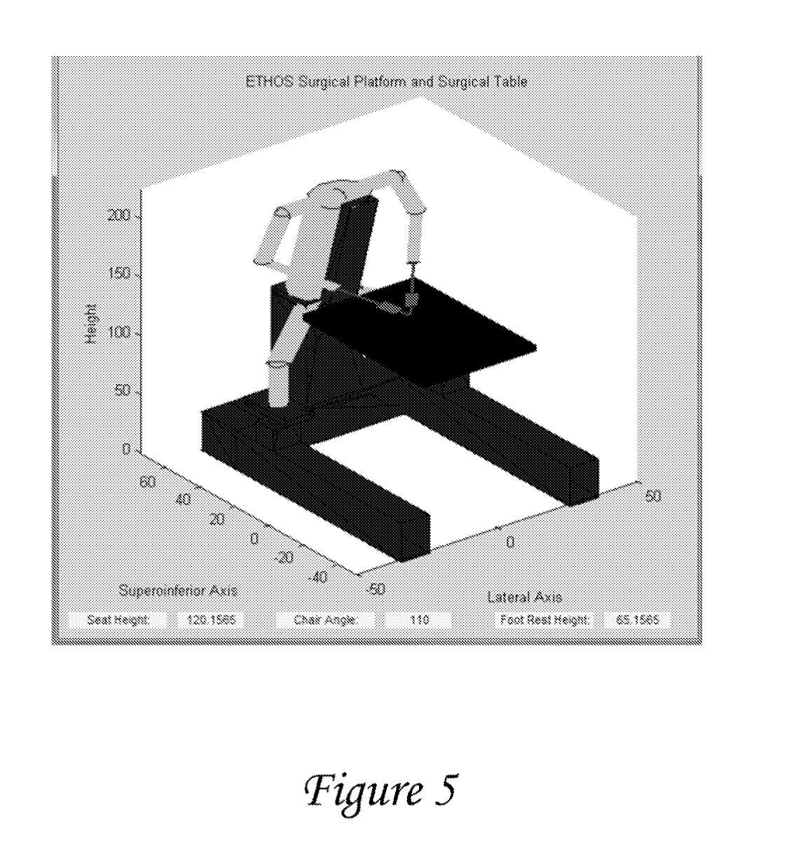

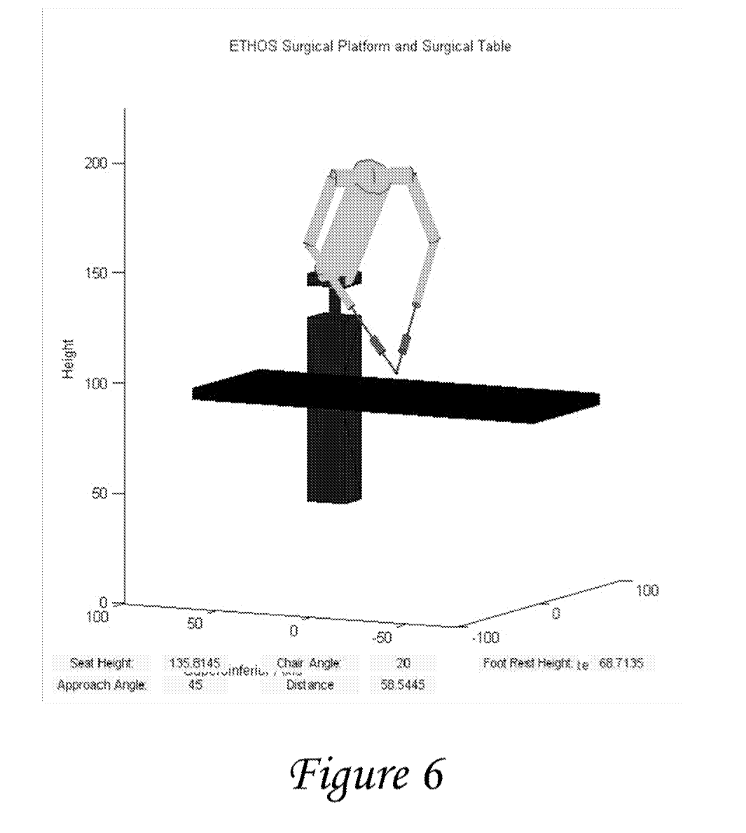

After the locations of the joints (204-215) of the user (10) have been calculated in space, as well as the calibration parameters (601-605), standard three-dimensional plotting software can be utilized to create a representation of the ergonomically ideal set-up. This is shown in FIG. 4 (a lateral view of the user sitting on the calibrated surgical platform) and FIG. 5 (a perspective view of the user sitting on the calibrated surgical platform). Similarly, if the approach angle is not zero, a perspective view (such as in FIG. 6) can be helpful to demonstrate the approach angle (604) needed with respect to the patient and the surgical table.

I, Charles Becker, of the City of Lexington in the Commonwealth of Kentucky, hereby claim:

1. A method for calibrating a surgical platform for use by a surgeon, comprising:
a. Inputting inputs of
i. a surgical site coordinate, wherein the surgical site coordinate represents the location of a site of surgery within a patient;
ii. a plurality of trochar coordinates, wherein the trochar coordinates represent the location of a plurality of trochars; and
iii. biometric information of the surgeon;
b. and adjusting at least one adjustable parameter of the surgical platform based on calibration information.

2. The method of claim 1, wherein biometric information includes at least one of: an arm length, a forearm length, a shoulder width, a back length, a thigh length, or a leg length.

3. The method of claim 1, wherein the calibration information includes at least one of: a seat height, a seat incline angle, a surgical approach angle, a platform distance from a patient, or a foot rest height.

4. The method of claim 1, wherein the surgical site coordinate and plurality of trochar coordinates are three-dimensional coordinates.

5. The method of claim 1, wherein the calibration information is calculated by a processor included within the surgical platform.

6. The method of claim 5, wherein the processor included within the surgical platform adjusts at least one adjustable parameter of the surgical platform based on the calibration information.

7. A system for calibrating a surgical platform for use by a surgeon, comprising:
a. Inputting inputs of
i. a surgical site coordinate, wherein the surgical site coordinate represents the location of a site of surgery within a patient;
ii. a plurality of trochar coordinates, wherein the trochar coordinates represent the location of a plurality of trochars; and
iii. biometric information of the surgeon;
b. outputting calibration information for adjusting at least one adjustable parameter of the surgical platform; and
c. and adjusting the at least one adjustable parameter of surgical platform based on the calibration information.

8. The system of claim 7, wherein biometric information includes at least one of: an arm length, a forearm length, a shoulder width, a back length, a thigh length, or a leg length.

9. The system of claim 7, wherein the calibration information includes at least one of: a seat height, a seat incline angle, a surgical approach angle, a platform distance from a patient, or a foot rest height.

10. The system of claim 7, wherein the surgical site coordinate and plurality of trochar coordinates are three-dimensional coordinates.

11. The system of claim 7, wherein the surgeon sits on the surgical platform.

12. The system of claim 7, wherein the calibration information is calculated by a processor included within the surgical platform.

13. The system of claim 12, wherein the processor included within the surgical platform adjusts at least one adjustable parameter of the surgical platform based on the calibration information.
